(19) United States
(12) Patent Application Publication
(10) Pub. No.: US 2012/0268062 A1
(43) Pub. Date: Oct. 25, 2012

(54) Charging connector mounting structure

(75) Inventor: Shin YONEDA, Hamamatsu (JP)

(73) Assignee: SUZUKI MOTOR CORPORATION, Hamamatsu (JP)

(21) Appl. No.: 13/442,718

(22) Filed: Apr. 9, 2012

(30) Foreign Application Priority Data
Apr. 19, 2011 (JP) 2011-093277

(51) Int. Cl. H02J 7/00

(52) U.S. Cl. 320/107

(57) ABSTRACT

A charging connector mounting structure is provided, which prevents entry of water into an outer panel and is highly versatile, includes: an opening provided in an outer panel located on a side face of a vehicle; an outer box mounted on a vehicle interior side of the opening and recessed toward the inside of the opening; a through-hole formed in a recessed portion of the outer box; a connector connecting portion which is inserted in the through-hole and to which a cable plug for charging a battery of the vehicle is connected; and an inner box that is mounted to an inner panel located on the vehicle interior side with respect to the outer panel and that supports the connector connecting portion, wherein the inner box is made of resin.

### CROSS-REFERENCE TO PENDING PROVISIONAL APPLICATION

This application is based upon and claims the benefit of priority from the prior Japanese Patent Application No. 2011-093277, filed on Apr. 19, 2011, the entire contents of which are incorporated herein by reference.

### FIELD

The present invention relates to a charging connector which is provided in a vehicle equipped with a battery capable of being charged from an external power supply, and into which a charging cable is inserted.

### BACKGROUND

The use of electric vehicles, hybrid cars and other automobiles that use an electric motor as the power source has been spreading these days. Such automobiles are equipped with a battery for supplying electricity to the electric motor.

There are several different methods for charging the battery, depending on the type of the battery and the automobile. For example, in the case of most hybrid cars, electricity is generated using the engine power to operate a generator, and the battery is charged with that electricity. In the case of electric vehicles and some hybrid cars (plug-in hybrid cars), it is possible to directly charge the battery from the external power supply by inserting a charging cable into the vehicle. Accordingly, a charging connector for insertion of a cable is installed in plug-in hybrid cars and the like (Japanese Patent Laid-open Publication No. H07-122328).

The charging connector is installed on the vehicle exterior such as a front grille or an outer panel, and therefore tends to be exposed to wind and rain. For this reason, in Japanese Patent Laid-open Publication No. H07-122328, for example, a rib is provided around a connector body (connector connecting portion) so as to prevent water from coming into contact with the connector body, and a drain hole is provided in a lower portion of a connector supporting portion. Such a drainage structure has been conventionally used. For example, in an oil supply fuel injection portion disclosed in Japanese Utility Model Publication No. H07-55142, a drainage outlet is also provided in a lower portion of an adapter (inner wall member) supporting a fuel injection pipe.

The charging connector is often provided passing through an outer panel and an inner panel, as in the case of the fuel injection portion of Japanese Utility Model Publication No. H07-55142. However, the configuration of the outer panel and the inner panel varies depending on the car type. Moreover, there are cases where the shape of the connector connecting portion may be improved. In such instances, newly building a charging connector for each car type is not efficient in terms of costs and labor.

In view of such problems, it is an object of the present invention to provide a charging connector mounting structure that can prevent entry of water into an outer panel and is highly versatile.

### SUMMARY OF THE DISCLOSURE

In order to solve the above-described problems, a typical configuration of a charging connector mounting structure according to the present invention includes: an opening provided in an outer panel located on a side face of a vehicle; an outer box mounted on a vehicle interior side of the opening and recessed toward the inside of the opening; a through-hole formed in a recessed portion of the outer box; a connector connecting portion which is inserted in the through-hole and to which a cable plug for charging a battery of the vehicle is connected; and an inner box that is mounted to an inner panel located on the vehicle interior side with respect to the outer panel and that supports the connector connecting portion, wherein the inner box is made of resin, and includes: a rib extending obliquely upward from a lower edge of a front face of the inner box to a location below the through-hole; and a drain hole provided in the front face above the rib and in communication with the space below the vehicle.

A charging connector mounting structure is provided that can prevent entry of water into an outer panel and is highly versatile. The charging connector mounting structure includes: an opening provided in an outer panel located on a side face of a vehicle; an outer box mounted on a vehicle interior side of the opening and recessed toward the inside of the opening; a through-hole formed in a recessed portion of the outer box; a connector connecting portion which is inserted in the through-hole and to which a cable plug for charging a battery of the vehicle is connected; and an inner box that is mounted to an inner panel located on the vehicle interior side with respect to the outer panel and that supports the connector connecting portion, wherein the inner box is made of resin, and includes: a rib extending obliquely upward from a lower edge of a front face of the inner box to a location below the through-hole; and a drain hole provided in the front face above the rib and in communication with the space below the vehicle.

With the above-described configuration, rain water or the like that has entered the opening flows along the rib of the inner box and is discharged underneath the vehicle from the drain hole. Accordingly, it is possible to prevent the formation of rust inside the outer panel and the inner panel. Moreover, the inner box is made of resin and thus easy to mold. Furthermore, the member directly supporting the connector connecting portion is the inner box, and it is therefore not necessary to increase the molding accuracy of the outer box. Accordingly, new charging connector mounting structures can be constructed for connector connecting portions having varying shapes by a simple shape alteration or by partly altering only the shape of the inner box, and thus high versatility can be achieved.

The rib may include a sealant in contact with the outer box. With this configuration, it is possible to prevent entry of water into the outer panel more efficiently.

With the above-described configuration, it is possible to provide a charging connector mounting structure that can prevent entry of water into the outer panel and is highly versatile.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a diagram illustrating an outline of a charging connector mounting structure according to an embodiment of the present invention.

FIG. 2 is an exploded view of the charging connector mounting structure in FIG. 1.

FIGS. 3A and 3B are diagrams illustrating the inner box in FIG. 2 alone.

FIGS. 4A and 4B are diagrams illustrating a water entry prevention mechanism provided by the inner box in FIGS. 3A and 3B.

### DETAILED DESCRIPTION

Hereinafter, a preferred embodiment of the present invention will be described in detail with reference to the accompanying drawings. The dimensions, materials, and other specific numerical values described in this embodiment are merely examples for facilitating the understanding of the present invention, and are not to be construed as limiting the invention unless otherwise stated. It should be noted that elements constituting substantially identical functions and configurations are denoted by identical reference numerals in the present specification and the drawings, and hence redundant description has been omitted. Also, illustration of elements that are not directly relevant to the present invention has been omitted.

### Charging Connector Mounting Structure

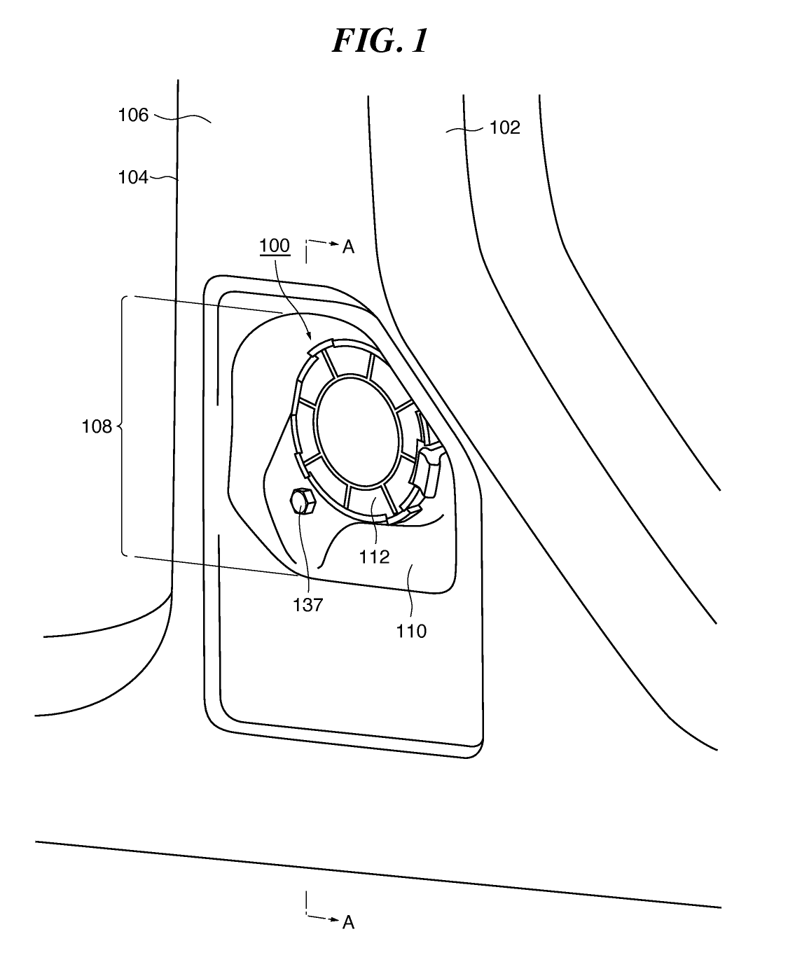

FIG. 1 is a diagram illustrating an outline of a charging connector attachment structure according to an embodiment of the present invention. A charging connector 100 is used when a battery (not shown) installed on a vehicle is charged. In this embodiment, the charging connector 100 is installed in an opening 108 that is provided on a side face of the vehicle in a lower portion of an outer panel 106 located between a front door area 102 and a rear door area 104. Note that the charging connector 100 is usually covered by an outer lid called a “fuel lid” (not shown) and thus is not visible from the outside.

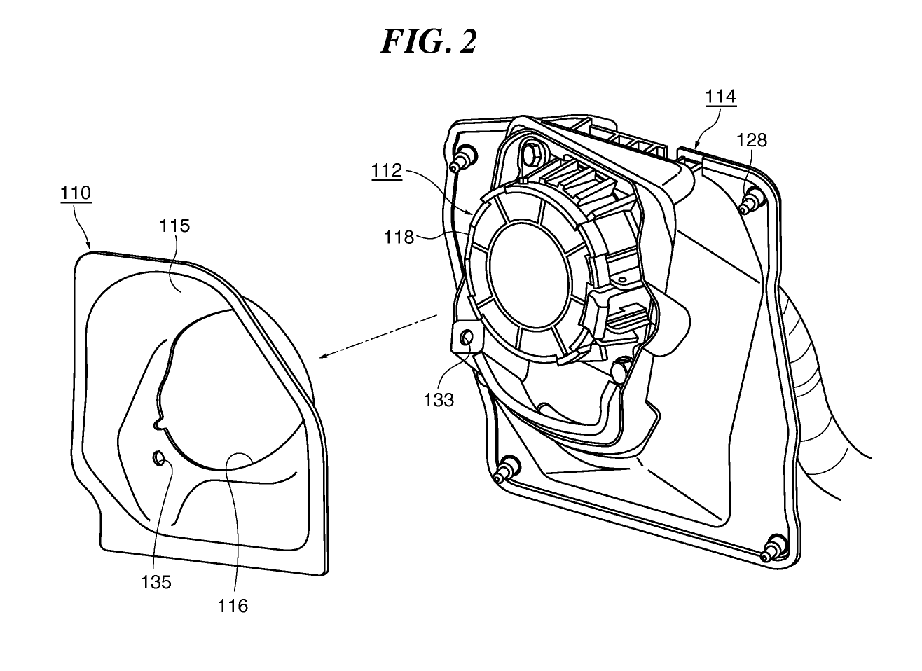

FIG. 2 is an exploded view of the charging connector mounting structure in FIG. 1. As illustrated in FIG. 2, the charging connector mounting structure can be divided into three main components, namely, an outer box 110, a connector connecting portion 112, and an inner box 114 supporting the connector connecting portion 112.

As illustrated in FIG. 1, the outer box 110 is a member that is mounted on the vehicle interior side of the opening 108 and constitutes the inner wall of the opening 108. The outer box 110 is recessed toward the inside of the opening 108, and has a through-hole 116 formed in a recessed portion 115 as illustrated in FIG. 2. The connector connecting portion 112 is inserted in the through-hole 116.

The connector connecting portion 112 has a terminal face covered by a connector lid 118 and is disposed with the terminal face facing the opening 108. The connector connecting portion 112 is connected to the battery (not shown) inside the vehicle, and a charging cable plug (not shown) extending from an external power supply can be connected to the connector connecting portion 112. The connector connecting portion 112 is mounted to the inner box 114, which supports the connector connecting portion 112.

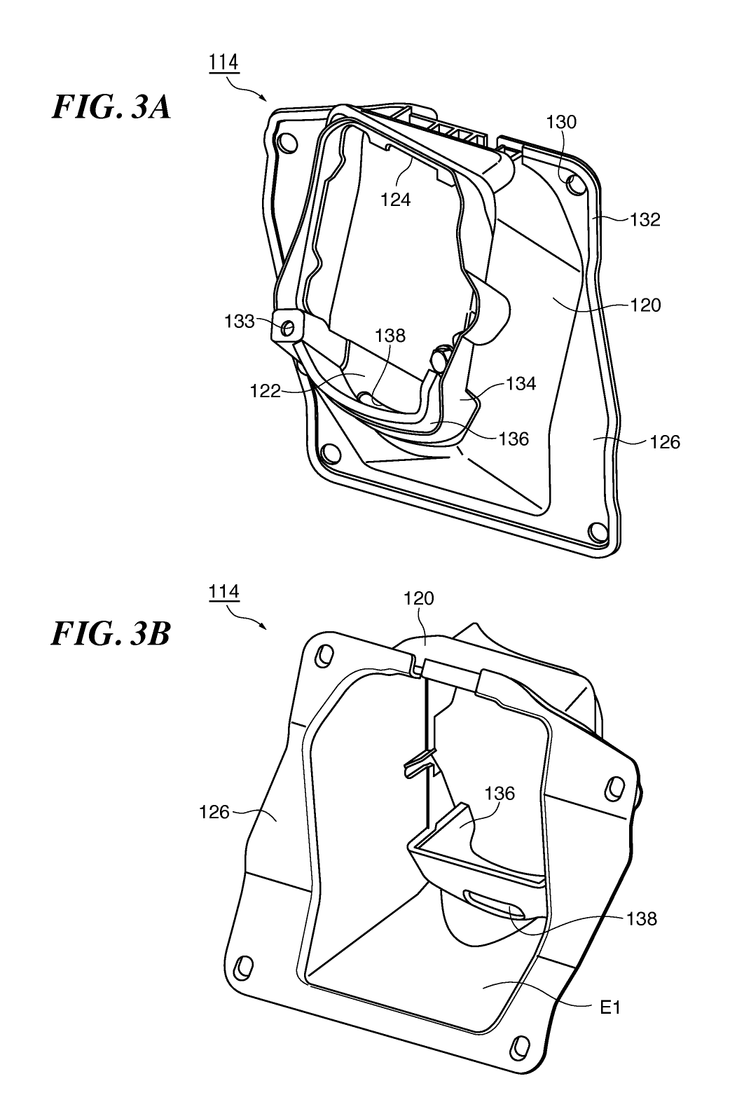

FIGS. 3A and 3B are diagrams illustrating the inner box 114 in FIG. 2 alone. FIG. 3A illustrates the inner box 114 from which the connector connecting portion 112 in FIG. 2 has been removed. FIG. 3B is a rear perspective view of the inner box 114 in FIG. 3A.

The inner box 114 illustrated in FIG. 3A is made of resin. The inner box 114 is provided with a base 120 that projects in a substantially rectangular shape. A large opening 124 is formed in a front face 122 of the base 120, and the connector connecting portion 112 is mounted in the opening 124.

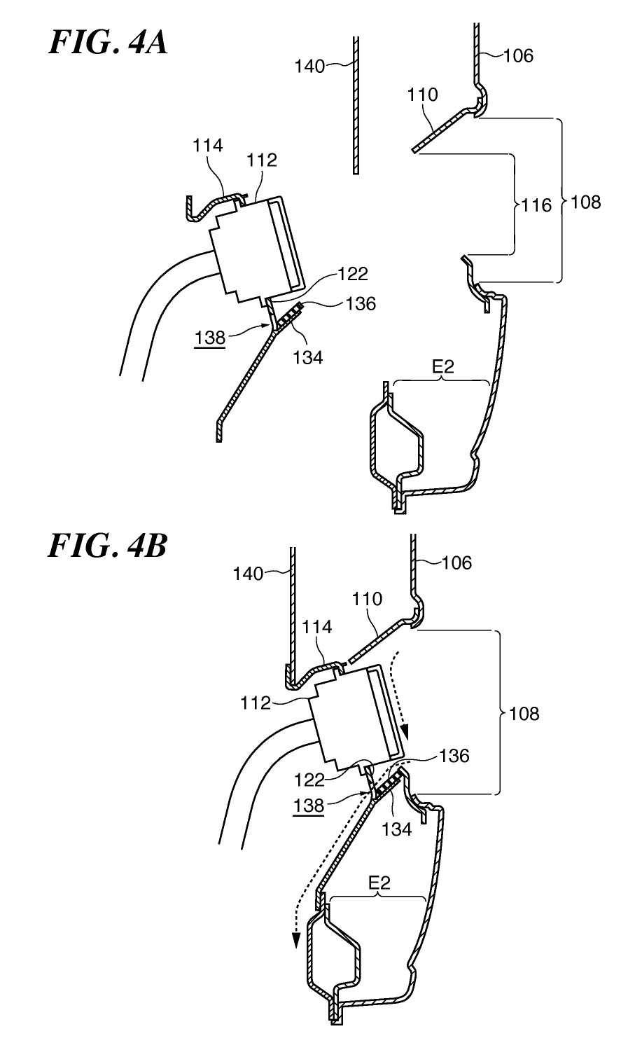

A flange portion 126 is provided at a basal portion of the base 120, and the flange portion 126 is provided with clip holes 130 for attachment of clips 128 (see FIG. 2) and a gasket 132. The inner box 114 is mounted to the inner panel 140 (see FIG. 4B) using the clips 128, and the gasket 132 functions as a sealing material at that time.

The inner box 114 is provided with a bolt hole 133. The bolt hole 133 is fastened to a bolt hole 135 of the outer box 110 using a bolt 137 shown in FIG. 1. This enhances the mounting stiffness of the inner box 114.

A rib 134 is provided around the front face 122 of the base 120. The rib 134, in particular the lower portion of the rib 134, functions as a region for water entry prevention, as described below. In order to achieve the water entry prevention efficiently, a sealant 136 is provided at the lower portion of the rib 134. Further, a drain hole 138 for water drainage is formed in the front face 122 above the rib 134. As illustrated in FIG. 3B, an area E1 to the rear of the drain hole 138 is inclined downward, and the area E1 serves as a path for water drainage using the drain hole 138.

FIGS. 4A and 4B are diagrams illustrating the water entry prevention mechanism provided by the inner box 114 in FIGS. 3A and 3B. FIG. 4A is a diagram illustrating a process of mounting the inner box 114. FIG. 4B is a diagram illustrating the inner box 114 after it has been mounted, and corresponds to a cross-sectional view taken along the arrows A-A in FIG. 1.

As illustrated in FIG. 4A, the outer box 110 is mounted to the vehicle interior side of the outer panel 106. Then, the inner box 114 combined with the connector connecting portion 112 is mounted to the inner panel 140 using the clips (see FIG. 2) or the like such that the connector connecting portion 112 is exposed from the through-hole 116 of the outer box 110. Note that it is also possible to adopt a configuration in which the inner box 114 is first mounted to the inner panel 140 and thereafter the connector connecting portion 112 is mounted.

A gap E2 is formed between the outer panel 106 and the inner panel 140 provided on the vehicle interior side with respect to the outer panel 106. Rust tends to be formed inside the gap E2, or in other words, the back side of the outer panel 106 and the inner panel 140 because rain water or the like accumulates once it has entered. Therefore, the rib 134 provided in the inner box 114 functions to prevent entry of water into the gap E2.

As illustrated in FIG. 4B, the rib 134 of the inner box 114 extends obliquely upward from the lower edge of the front face 122 to a location below the through-hole 116 of the outer box 110. Also, the sealant 136 provided at the rib 134 is in contact with the outer box 110, thus closing the gap E2. Since the drain hole 138 is formed in a basal portion of the rib 134, even if rain water flows down through the inside of the opening 108, that rain water will not enter the gap E2. Instead, the rain water will flow through the drain hole 138 from the rib 134 and be discharged underneath the vehicle.

With the above-described configuration, it is possible to efficiently prevent the formation of rust inside the outer panel 106 and the inner panel 140. Also, the inner box 114 is made of resin (plastic) and thus easy to mold. Furthermore, the member directly supporting the connector connecting portion 112 is the inner box 114, and therefore it is not necessary to increase the molding accuracy of the outer box 110, for example, for the through-hole 116. Accordingly, the charging connector mounting structure is highly versatile. Moreover, it is possible to construct new charging connector mounting structures for connector connecting portions having various configurations by a simple shape alteration or by partly altering only the shape of the inner box 114.

While a preferred embodiment of the present invention has been described above with reference to the accompanying drawings, it should be appreciated that the present invention is not limited to the embodiment shown above. It will be apparent for a person skilled in the art that various modifications and variations may be made within the scope of the invention as defined in the appended claims, and those modifications and variations should be understood to be included within the technical scope of the present invention.

The present invention is applicable as a charging connector which is provided in a vehicle equipped with a battery capable of being charged from an external power supply and into which a charging cable is inserted.

1. A charging connector mounting structure comprising:
an opening provided in an outer panel located on a side face of a vehicle;
an outer box mounted on a vehicle interior side of the opening and recessed toward the inside of the opening;
a through-hole formed in a recessed portion of the outer box;
a connector connecting portion which is inserted in the through-hole and to which a cable plug for charging a battery of the vehicle is connected; and
an inner box that is mounted to an inner panel located on the vehicle interior side with respect to the outer panel and that supports the connector connecting portion,
wherein the inner box is made of resin, and includes:
a rib extending obliquely upward from a lower edge of a front face of the inner box to a location below the through-hole; and
a drain hole provided in the front face above the rib and in communication with the space below the vehicle.

2. The charging connector mounting structure according to claim 1, wherein the rib comprises a sealant in contact with the outer box.
